(19) United States
(12) Patent Application Publication
(10) Pub. No.: US 2026/0280903 A1
(43) Pub. Date: Sep. 17, 2026

(54) PROCESSING APPARATUS, METHOD, AND NON-TRANSITORY COMPUTER-READABLE MEDIUM

(71) Applicant: NEC Corporation, Minato-ku, Tokyo (JP)

(72) Inventor: Yoshifumi HORIE, Tokyo (JP)

(73) Assignee: NEC Corporation, Minato-ku, Tokyo (JP)

(21) Appl. No.: 19/027,118

(22) Filed: Jan. 17, 2025

(30) Foreign Application Priority Data
Feb. 26, 2024 (JP) 2024-026641

(51) Int. Cl. H04L 9/32; H04L 9/08

(52) U.S. Cl. CPC H04L 9/3268; H04L 9/0852

(57) ABSTRACT

A processing apparatus for which a normal environment and a secured environment are provided, includes a validity check processing unit configured to operate in the normal environment and receive a revocation check request for a public key certificate, a validity management unit configured to operate in the normal environment and output information about validity of a public key certificate corresponding to the received revocation check request, and an inspection unit configured to operate in the secured environment and inspect normality of the validity management unit.

### INCORPORATION BY REFERENCE

This application is based upon and claims the benefit of priority from Japanese patent application No. 2024-026641, filed on Feb. 26, 2024, the disclosure of which is incorporated herein in its entirety by reference.

### TECHNICAL FIELD

The present disclosure relates to a processing apparatus, a method, and a program.

### BACKGROUND ART

OCSP (Online Certificate Status Protocol) is known as a communication protocol for acquiring a revocation state of a public key certificate (see, for example, Non-patent Literature 1). In public key infrastructure (PKI), when a certificate issued by a certificate authority (CA) is revoked, it creates a certificate revocation list (CRL). An OCSP responder (i.e., a validity management function) can acquire the CRL and check the validity of the certificate by using the CRL.

Non-patent Literature 1: Stefan Santesson, Michael Myers, Rich Ankney, Ambarish Malpani, Slava Galperin, Carlisle Adams, “X. 509 Internet Public Key Infrastructure Online Certificate Status Protocol—OCSP”, Internet Engineering Task Force (IETF), Request for Comments: 6960, June 2013

### SUMMARY

However, when the normality of the validity management function is not guaranteed, the authenticity of information about the validity of the public key certificate may not be guaranteed.

An object of the present disclosure is to provide a processing apparatus, a method, and a program capable of improving the authenticity of information about the validity of a public key certificate.

A program according to the present disclosure causes a processing apparatus for which a normal environment and a secured environment are provided to perform processes including: receiving a revocation check request for a public key certificate in the normal environment; outputting information about validity of a public key certificate corresponding to the received revocation check request in the normal environment; and inspecting normality of the normal environment in the secured environment.

A processing apparatus according to the present disclosure is a processing apparatus for which a normal environment and a secured environment are provided, including: a validity check processing unit configured to operate in the normal environment and receive a revocation check request for a public key certificate; a validity management unit configured to operate in the normal environment and output information about validity of a public key certificate corresponding to the received revocation check request; and an inspection unit configured to operate in the secured environment and inspect normality of the validity management unit.

A method according to the present disclosure is a method performed by a processing apparatus for which a normal environment and a secured environment are provided, including: receiving a revocation check request for a public key certificate in the normal environment; outputting information about validity of a public key certificate corresponding to the received revocation check request in the normal environment; and inspecting normality of the normal environment in the secured environment.

According to the present disclosure, it is possible to provide a processing apparatus, a method, and a program capable of improving the authenticity of information about the validity of a public key certificate.

### BRIEF DESCRIPTION OF DRAWINGS

The above and other aspects, features and advantages of the present disclosure will become more apparent from the following description of certain example embodiments when taken in conjunction with the accompanying drawings, in which:

FIG. 1 shows an example of a system according to the present disclosure;

FIG. 2 is a block diagram showing an example of a processing apparatus according to the present disclosure;

FIG. 3 is a flowchart showing an example of processing operations performed by a processing apparatus according to the present disclosure;

FIG. 4 shows another example of a system according to the present disclosure;

FIG. 5 is a block diagram showing another example of a processing apparatus according to the present disclosure;

FIG. 6 is a flowchart showing another example of processing operations performed by a processing apparatus according to the present disclosure;

FIG. 7 shows another example of a system according to the present disclosure;

FIG. 8 is a block diagram showing another example of a processing apparatus according to the present disclosure;

FIG. 9 shows an example of a management table according to the present disclosure;

FIG. 10 is a flowchart showing another example of processing operations performed by a processing apparatus according to the present disclosure;

FIG. 11 is a flowchart showing another example of processing operations performed by a processing apparatus according to the present disclosure; and

FIG. 12 shows an example of a configuration of a processing apparatus.

### EXAMPLE EMBODIMENT

An example embodiment will be described hereinafter with reference to the drawings. Note that in the present disclosure, the drawings may be associated with one or a plurality of example embodiments. Further, each element shown in the drawings may be applicable to one or a plurality of example embodiments. Further, in an example embodiment, the same or equivalent elements are assigned the same reference numerals (or symbols), and redundant descriptions thereof are omitted.

### First Example Embodiment

### Overview of System

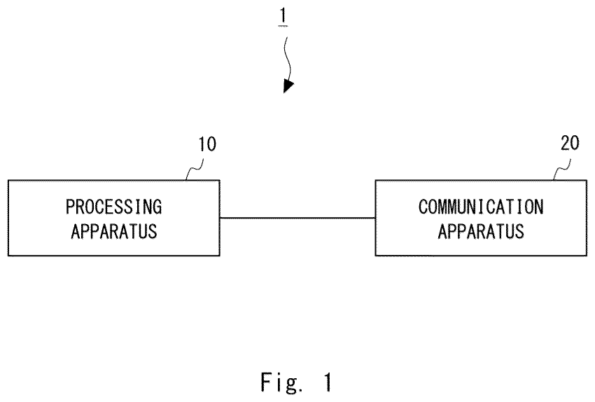

FIG. 1 shows an example of a system according to the present disclosure. In FIG. 1, the system 1 includes a processing apparatus 10 and a communication apparatus 20.

The communication apparatus 20 transmits, to the processing apparatus 10, a revocation check request for a public key certificate which is to be checked as to whether it has been revoked or not. For example, the public key certificate is a public key certificate of a web server that the communication apparatus 20 is about to access by using a browser. The public key certificate includes, for example, a public key of the web server and a digital signature of a certificate authority that issued this public key certificate.

The processing apparatus 10 transmits, to the communication apparatus 20, information about the validity of a public key certificate corresponding to the revocation check request.

### Example of Configuration of Processing Apparatus

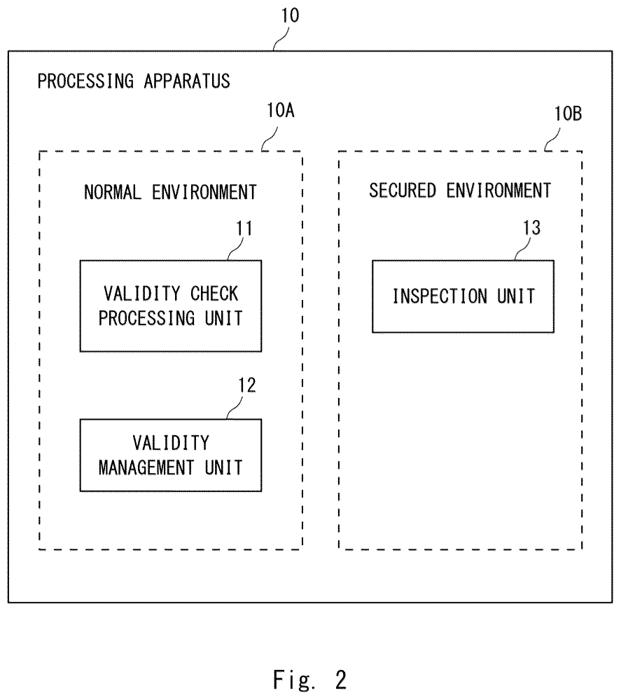

FIG. 2 is a block diagram showing an example of a processing apparatus according to the present disclosure. In FIG. 2, the processing apparatus (processor) 10 includes a virtual processor (normal environment) 10A and a virtual processor (secured environment) 10B. The normal environment 10A corresponds to an REE (Rich Execution Environment) and the secured environment 10B corresponds to a TEE (Trusted Execution Environment). The TEE is provided as a Trust Zone in the processor architecture of ARM (Advanced RISC Machines) and as SGX (Software Guard Extensions) in the processor architecture of Intel.

Further, in FIG. 2, the processing apparatus 10 includes a validity check processing unit 11, a validity management unit 12, and an inspection unit 13. The validity check processing unit 11 and the validity management unit 12 operate in the normal environment 10A, while the inspection unit 13 operates in the secured environment 10B. Note that the validity check processing unit 11 and the validity management unit 12 correspond to a validation authority function for verifying a public key certificate.

The validity check processing unit 11 receives a revocation check request for a public key certificate. The revocation check request may include a public key certificate.

The validity management unit 12 outputs “information about the validity of a public key certificate” corresponding to the received revocation check request. Note that the validity check processing unit 11 may transmit the information about the validity of the public key certificate to the apparatus that has transmitted the revocation check request (i.e., the communication apparatus 20 in this example).

The inspection unit 13 checks the normality of the validity management unit 12 (i.e., the normal environment 10A). For example, the inspection unit 13 may hold a correct hash value of an execution code of an operation program of the validity management unit 12. Then, the inspection unit 13 acquires the execution code of the operation program of the validity management unit 12 from a memory (not shown). Then, the inspection unit 13 calculates a hash value of the acquired execution code based thereon. An algorithm used for the calculation of the hash value is not limited to any particular algorithm, and may be, for example, SHA1 or SHA256. Then, the inspection unit 13 checks the normality of the validity management unit 12 based on the calculated hash value and the correct hash value. For example, the inspection unit 13 determines that the validity management unit 12 is normal (has not been tampered with) when the calculated hash value and the correct hash value match each other, and determines that the validity management unit 12 is abnormal (has been tampered with) when these values do not match each other.

### Example of Operation of Processing Apparatus

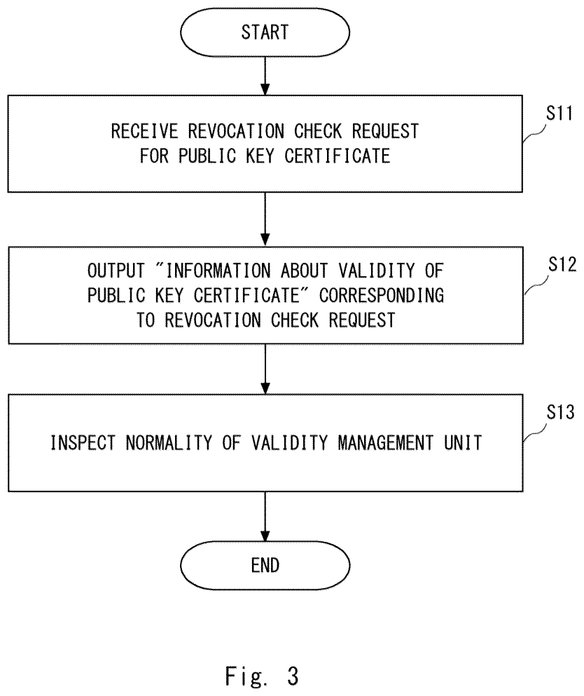

FIG. 3 is a flowchart showing an example of processing operations performed by the processing apparatus according to the present disclosure.

The validity check processing unit 11 receives a revocation check request for a public key certificate (Step S11).

The validity management unit 12 outputs “information about the validity of a public key certificate” corresponding to the received revocation check request (Step S12).

The inspection unit 13 inspects the normality of the validity management unit 12 (Step S13).

As described above, according to the first example embodiment, in the processing apparatus 10, the validity management unit 12 operates in the normal environment 10A and outputs “information about the validity of a public key certificate” corresponding to the revocation check request received by the validity check processing unit 11. The inspection unit 13 operates in the secured environment 10B and checks the normality of the validity management unit 12 (i.e., the normal environment 10A).

By the above-described configuration of the processing apparatus 10, the inspection unit 13, which operates in the secured environment 10B, inspects the normality of the validity management unit 12 (i.e., the normal environment 10A), so that it is possible to inspect the normality of the validity management unit 12 (i.e., the normal environment 10A) while guaranteeing the authenticity of the inspection unit 13. Therefore, the normality of the validity management unit 12 (i.e., the normal environment 10A) can be guaranteed. As a result, the authenticity of the information about the validity of the public key certificate output from the validity check processing unit 11 can be guaranteed.

Note that the above-described inspection of the normality of the validity management unit 12 by the inspection unit 13 may be directly or indirectly performed. For example, the processing apparatus 10 may include an inspection processing unit that operates in the normal environment 10A and inspects the normality of the validity management unit 12 (not shown). Then, the inspection unit 13 may inspect the normality of the inspection processing unit (not shown). In this case, for example, the inspection unit 13 holds a correct hash value of an execution code of an operation program of the inspection processing unit (not shown). Then, the inspection unit 13 acquires the execution code of the operation program of the inspection processing unit (not shown) from a memory (not shown). Then, the inspection unit 13 calculates the hash value of the acquired execution code based thereon. Then, the inspection unit 13 checks the normality of the inspection processing unit (not shown) based on the calculated hash value and the correct hash value. For example, when the calculated hash value and the correct hash value match each other, the inspection unit 13 determines that the inspection processing unit (not shown) is normal (has not been tampered with) and the validity management unit 12 is also normal. On the other hand, when the calculated hash value and the correct hash value do not match each other, the inspection unit 13 determines that the inspection processing unit (not shown) is abnormal (has been tampered with) and the validity management unit 12 is also abnormal. In this way, the inspection unit 13 can indirectly inspect the normality of the validity management unit 12.

### Second Example Embodiment

### Overview of System

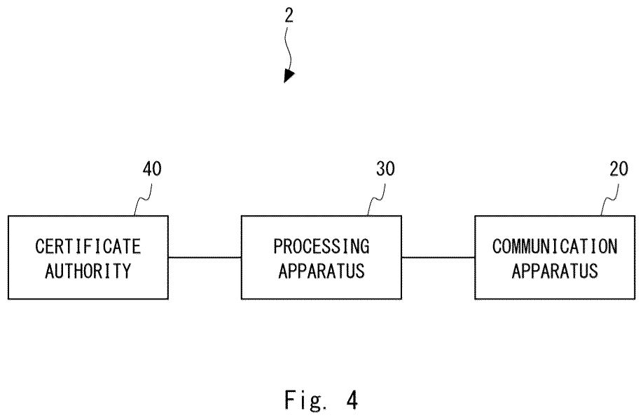

FIG. 4 shows another example of a system according to the present disclosure. In FIG. 4, the system 2 includes a processing apparatus 30, a communication apparatus 20, and a certificate authority 40.

When the certificate authority 40 revokes a public key certificate that it issued, it creates a certificate revocation list (CRL).

The processing apparatus 30 acquires the certificate revocation list from the certificate authority 40 and holds the acquired certificate revocation list.

The processing apparatus 30 forms, i.e., creates, information about the validity of a public key certificate corresponding to a revocation check request based on the certificate revocation list. The processing apparatus 30 transmits the information about the validity of the public key certificate corresponding to the revocation check request to the communication apparatus 20.

### Example of Configuration of Processing Apparatus

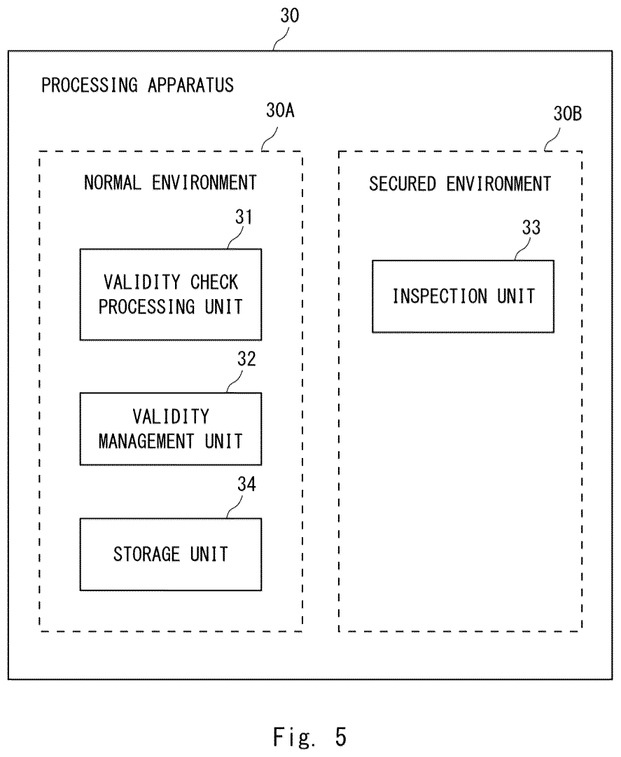

FIG. 5 is a block diagram showing another example of a processing apparatus according to the present disclosure. In FIG. 5, the processing apparatus (processor) 30 includes a virtual processor (normal environment) 30A and a virtual processor (secured environment) 30B.

Further, in FIG. 5, the processing apparatus 30 includes a validity check processing unit 31, a validity management unit 32, an inspection unit 33, and a storage unit 34. The validity check processing unit 31 and the validity management unit 32 operate in the normal environment 30A, while the inspection unit 33 operates in the secured environment 30B. Further, the storage unit 34 is disposed in the normal environment 30A.

Similarly to the validity check processing unit 11, the validity check processing unit 31 receives a revocation check request for a public key certificate. Similarly to the validity check processing unit 11, the validity check processing unit 31 may transmit information about the validity of a public key certificate to the apparatus that has transmitted the revocation check request (i.e., the communication apparatus 20 in this example).

The validity management unit 32 acquires a certificate revocation list used for the determination of the validity from the certificate authority 40 and stores the acquired certificate revocation list in the storage unit 34.

The validity management unit 32 determines the validity of a public key certificate corresponding to the revocation check request by referring to the certificate revocation list stored in the storage unit 34. For example, when information identifying the public key certificate corresponding to the revocation check request is recorded in the certificate revocation list, the validity management unit 32 determines that the public key certificate corresponding to the revocation check request has been revoked. On the other hand, when no information identifying the public key certificate corresponding to the revocation check request is recorded in the certificate revocation list, the validity management unit 32 determines that the public key certificate corresponding to the revocation check request has not been revoked.

The validity management unit 32 outputs the result of the determination of the validity of the public key certificate corresponding to the revocation check request as information about the validity of the public key certificate.

Similarly to the inspection unit 13, the inspection unit 33 checks the normality of the validity management unit 32 (i.e., the normal environment 30A). Further, the inspection unit 33 may also detect tampering with the storage unit 34.

### Example of Operation of Processing Apparatus

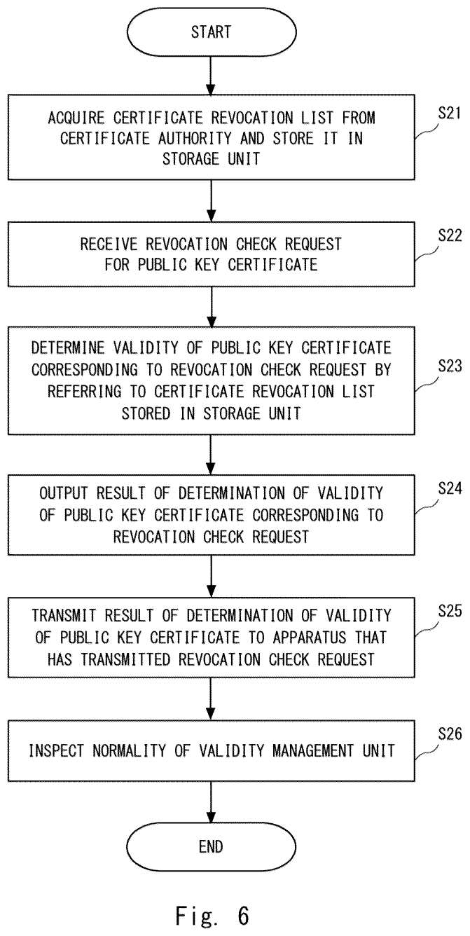

FIG. 6 is a flowchart showing another example of processing operations performed by the processing apparatus according to the present disclosure.

The validity management unit 32 acquires a certificate revocation list from the certificate authority 40 and stores the acquired certificate revocation list in the storage unit 34 (Step S21).

The validity check processing unit 11 receives a revocation check request for a public key certificate (Step S22).

The validity management unit 32 determines the validity of the public key certificate corresponding to the revocation check request by referring to the certificate revocation list stored in the storage unit 34 (Step S23).

The validity management unit 32 outputs the result of the determination of the validity of the public key certificate corresponding to the revocation check request (Step S24).

The validity check processing unit 31 transmits the result of the determination of the validity of the public key certificate to the apparatus that has transmitted the revocation check request (i.e., the communication apparatus 20 in this example) (Step S25).

The inspection unit 33 checks the normality of the validity management unit 32 (i.e., the normal environment 30A) (Step S26).

### Modified Example

Note that when the validity management unit 32 (i.e., the normal environment 30A) is determined to be normal as a result of the inspection of the normality of the validity management unit 32 (i.e., the normal environment 30A), the validity check processing unit 31 may transmit the result of the determination of the validity of the public key certificate. On the other hand, when the validity management unit 32 (i.e., the normal environment 30A) is determined not to be normal, the validity check processing unit 31 may not transmit the result of the determination of the validity of the public key certificate. Alternatively, when the validity management unit 32 (i.e., the normal environment 30A) is determined not to be normal, the validity check processing unit 31 may transmit the result of the determination of the validity of the public key certificate together with information indicating that the reliability of the result of the determination is low.

### Third Example Embodiment

### Overview of System

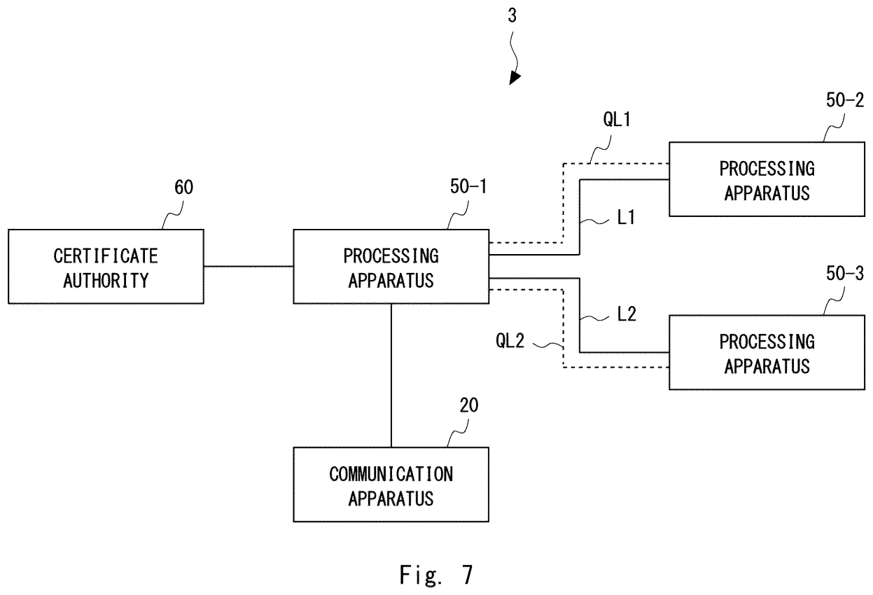

FIG. 7 shows another example of a system according to the present disclosure. In FIG. 7, the system 3 includes processing apparatuses 50-1, 50-2, and 50-3, a communication apparatus 20, and a certificate authority 60. In the following description, when the processing apparatuses 50-1, 50-2, and 50-3 are not distinguished from one another, the processing apparatuses 50-1, 50-2, and 50-3 may be collectively referred to as processing apparatuses 50, or each of them may be simply referred to as a processing apparatus 50. Note that although the number of processing apparatuses 50 is three in FIG. 7, the number of processing apparatuses 50 may be two, or four or more.

The processing apparatus 50-1 is connected to the processing apparatus 50-2 by a quantum key distribution link QL1. Further, the processing apparatus 50-1 is also connected to the processing apparatus 50-2 by a communication link L1 used for normal data communication, which is different from the quantum key distribution link QL1. Communication through the communication link L1 may be communication using an encryption key generated based on information delivered through the quantum key distribution link QL1.

Further, the processing apparatus 50-1 is connected to the processing apparatus 50-3 by a quantum key distribution link QL2. Further, the processing apparatus 50-1 is also connected to the processing apparatus 50-3 by a communication link L2 used for normal data communication, which is different from the quantum key distribution link QL2. Communication through the communication link L2 may be communication using an encryption key generated based on information delivered by the quantum key distribution link QL2. That is, each of the processing apparatuses 50-1, 50-2, and 50-3 is a trusted node that transmit and receive an encryption key using a quantum key distribution link.

Each of the processing apparatuses 50-1, 50-2, and 50-3 reports a quantum bit error rate (QBER) of the quantum key distribution link of which that processing apparatus is the receiving node to the certificate authority 60 at a predetermined timing. The processing apparatuses 50-1, 50-2, and 50-3 may report the quantum bit error rate to the certificate authority, for example, at regular intervals. For example, the quantum key distribution link of which the processing apparatus 50-1 is the transmitting node and the processing apparatus 50-2 is the receiving node is called a quantum key distribution link QL11. Further, the quantum key distribution link of which the processing apparatus 50-2 is the transmitting node and the processing apparatus 50-1 is the receiving node is called a quantum key distribution link QL12. Further, the quantum key distribution link of which the processing apparatus 50-1 is the transmitting node and the processing apparatus 50-3 is the receiving node is called a quantum key distribution link QL21. Further, the quantum key distribution link of which the processing apparatus 50-3 is the transmitting node and the processing apparatus 50-1 is the receiving node is called a quantum key distribution link QL22. In the above-described situation, the processing apparatus 50-1 measures the quantum bit error rate of the quantum key distribution link QL12 and that of the quantum key distribution link QL22, and reports each of the measurement results to the certificate authority 60. Further, the processing apparatus 50-2 measures the quantum bit error rate of the quantum key distribution link QL11, and reports the measurement result to the certificate authority 60. Further, the processing apparatus 50-3 measures the quantum bit error rate of the quantum key distribution link QL21, and reports the measurement result to the certificate authority 60. Note that each processing apparatus 50 may transmit, to the certificate authority 60, the measurement result of the quantum bit error rate together with identification information of the QKD link related to the measurement result. The identification information of a QKD link may be, for example, a combination of an identifier of the transmitting node and an identifier of the receiving node, or an identification number that is assigned to a respective quantum key distribution link in advance.

The certificate authority 60 creates a management table of quantum bit error rates based on the reports from the processing apparatuses 50-1, 50-2, and 50-3. Then, the certificate authority 60 transmits the crated management table to the processing apparatuses 50. The certificate authority 60 may transmit the management table to the processing apparatuses 50 every time it updates the management table. In this way, the processing apparatuses 50 can update the management table at regular intervals.

### Example of Configuration of Processing Apparatus

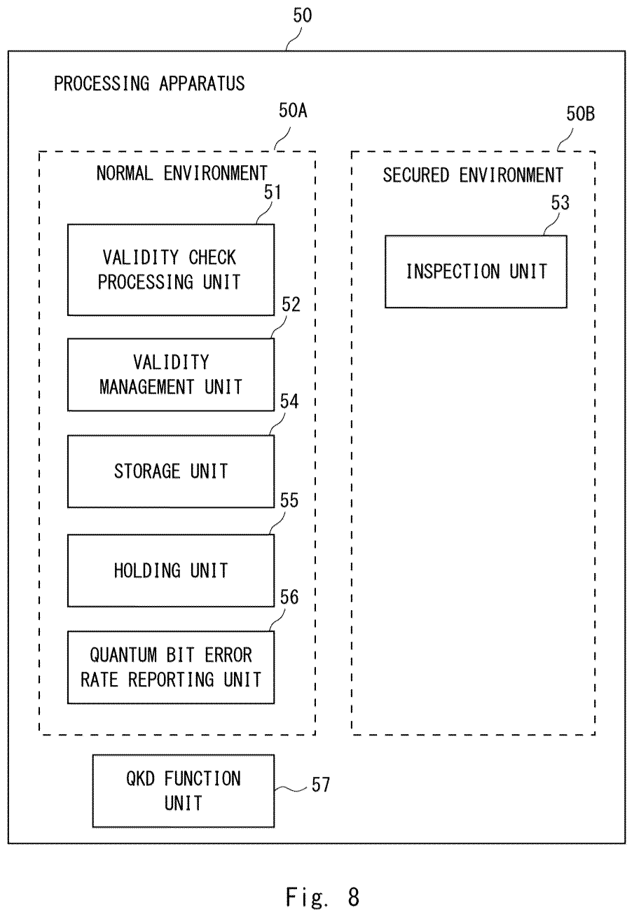

FIG. 8 is a block diagram showing another example of a processing apparatus according to the present disclosure. In FIG. 8, the processing apparatus (processor) 50 includes a virtual processor (normal environment) 50A and a virtual processor (secured environment) 50B.

Further, in FIG. 8, the processing apparatus 50 includes a validity check processing unit 51, a validity management unit 52, an inspection unit 53, a storage unit 54, a holding unit 55, a quantum bit error rate reporting unit 56, and a QKD function unit 57. The validity check processing unit 51, the validity management unit 52, and the quantum bit error rate reporting unit 56 operate in the normal environment 50A, while the inspection unit 53 operates in the secured environment 50B. Further, the storage unit 54 and the holding unit 55 may be disposed in the normal environment 50A. The QKD function unit 57 may be disposed in the normal environment 50A. Note that since the configurations of the processing apparatuses 50-1, 50-2, and 50-3 are identical to one another, only the configuration of the processing apparatus 50-1 will be described as an example.

The QKD function unit 57 transmits an encryption key to adjacent nodes (the processing apparatuses 50-2 and 50-3 in this example) through the quantum key distribution links. Further, the QKD function unit 57 receives encryption keys from adjacent nodes (the processing apparatuses 50-2 and 50-3 in this example) through the quantum key distribution links. In this process, the QKD function unit 57 measures a quantum bit error rate. The quantum bit error rate indicates, in regard to the encryption key transmitted by QKD (quantum key distribution), a probability that a bit value transmitted from the transmitter (Alice) and a bit value received by the receiver (Bob) differ from each other. The quantum bit error rate decreases due to, in addition to the space attenuation, an abnormality or eavesdropping in the propagation path (optical fiber). That is, the quantum bit error rate can be used as a parameter for the reliability of the quantum key distribution link and, as a result, for the reliability of an adjacent node(s) (e.g., the reliability of a validity management unit(s) of an adjacent node(s)).

The quantum bit error rate reporting unit 56 transmits the quantum bit error rate measured by the QKD function unit 57 to the certificate authority 60. As described above, the quantum bit error rate reporting unit 56 of the processing apparatus 50-1 transmits the quantum bit error rate of the quantum key distribution link QL12 and that of the quantum key distribution link QL22 to the certificate authority 60.

When the validity check processing unit 51 receives the management table from the certificate authority 60, it makes, e.g., instructs the holding unit 55 hold the received management table.

Similarly to the validity check processing unit 11, the validity check processing unit 51 receives a revocation check request for a public key certificate.

The validity check processing unit 51 refers to the management table held in the holding unit 55 and selects, as an apparatus through which it checks the validity of the public key certificate, the validity management unit 52 of the transmitting node of the quantum key distribution link having the highest reliability (e.g., the lowest quantum bit error rate) in the management table.

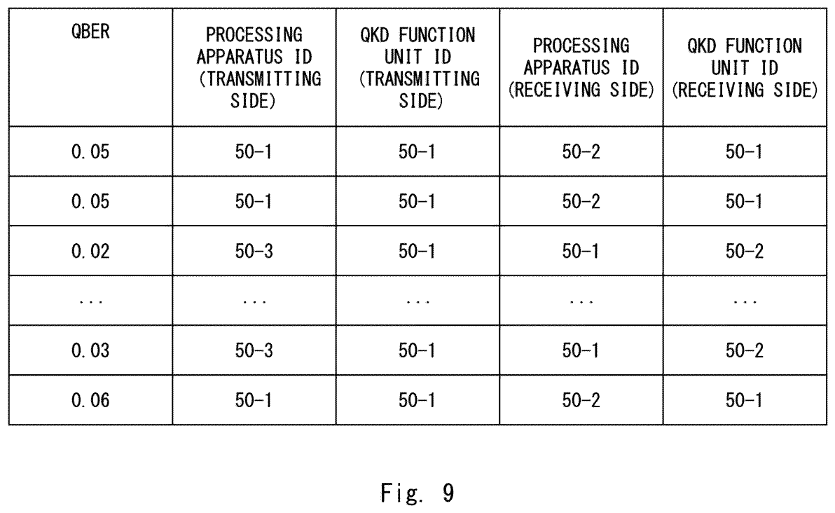

FIG. 9 shows an example of a management table according to the present disclosure. As shown in FIG. 9, in the management table, a plurality of pieces of identification information of quantum key distribution links and quantum bit error rates of quantum key distribution links corresponding to the plurality of pieces of identification information are recorded in association with each other. In the example shown in FIG. 9, the identification information of a quantum key distribution link includes an ID of a processing apparatus on the transmitting side, an ID of a QKD function unit on the transmitting side, an ID of a processing apparatus on the receiving side, and an ID of a QKD function unit on the receiving side. Note that in FIG. 9, for the sake of convenience, the symbols of the processing apparatuses 50-1, 50-2, and 50-3 are used as IDs of processing apparatuses and IDs of QKD function units.

When the validity check processing unit 51 refers to the management table shown in FIG. 9, it selects, as the apparatus through which it checks the validity of the public key certificate, the validity management unit 52 of the processing apparatus 50-3, which is the transmitting node of the quantum key distribution link having the lowest quantum bit error rate value, i.e., “QBER=0.02”.

Referring to FIG. 8 again, the validity check processing unit 51 transmits a revocation check request for a public key certificate to the validity management unit 52 of the processing apparatus 50, which has been selected as the apparatus through which the validity of the public key certificate is checked. When the validity check processing unit 51 receives the result of the determination of the validity of the public key certificate (i.e., information about the validity of the public key certificate) from the validity management unit 52, which is the apparatus through which the validity of the public key certificate is checked, it transmits the result of the determination of the validity of the public key certificate to the communication apparatus 20, which is the apparatus that has transmitted the revocation check request.

When the validity check processing unit 51 receives a revocation check request from another processing apparatus 50 (i.e., the processing apparatus 50-2 or 50-3), it requests the validity management unit 52 of the processing apparatus 50-1 to check the validity of the public key certificate. That is, the validity check processing unit 51 outputs the revocation check request to the validity management unit 52 of the processing apparatus 50-1. When the validity check processing unit 51 receives the result of the determination of the validity of the public key certificate from the validity management unit 52 of the processing apparatus 50-1, it transmits the result of the determination of the validity of the public key certificate to the other processing apparatus 50 (i.e., the processing apparatus 50-2 or 50-3), which is the apparatus that has transmitted the revocation check request.

The validity management unit 32 acquires a certificate revocation list used for the determination of the validity from the certificate authority 60 and stores the acquired certificate revocation list in the storage unit 54.

Upon receiving the revocation check request from the validity check processing unit 51, the validity management unit 52 determines the validity of the public key certificate corresponding to the revocation check request by referring to the certificate revocation list stored in the storage unit 34. The validity management unit 52 outputs the result of the determination of the validity of the public key certificate corresponding to the revocation check request to the validity check processing unit 51 as information about the validity of the public key certificate.

Similarly to the inspection unit 13, the inspection unit 53 checks the normality of the validity management unit 52 (i.e., the normal environment 50A). Further, the inspection unit 53 may also detect tampering with the storage unit 54.

### Example of Operation of Processing Apparatus

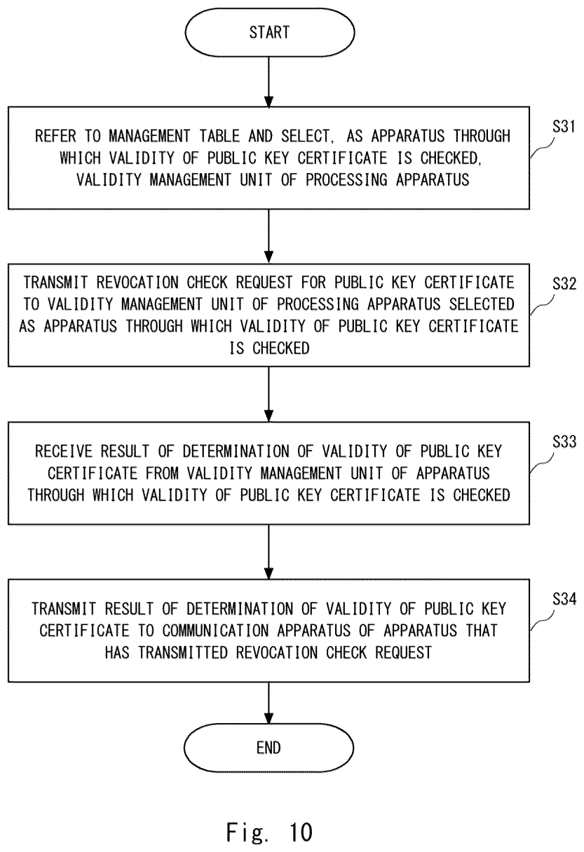

FIG. 10 is a flowchart showing another example of processing operations performed by the processing apparatus according to the present disclosure. The processing flow shown in FIG. 10 starts when the validity check processing unit 51 receives a revocation check request for a public key certificate. FIG. 10 shows a processing flow that is performed when the validity check processing unit 51 receives a revocation check request from the communication apparatus 20.

The validity check processing unit 51 refers to the management table held in the holding unit 55 and selects, as an apparatus through which it checks the validity of the public key certificate, the validity management unit 52 of the transmitting node of the quantum key distribution link having the highest reliability in the management table (Step S31).

The validity check processing unit 51 transmits a revocation check request for a public key certificate to the validity management unit 52 of the processing apparatus 50, which has been selected as the apparatus through which the validity of the public key certificate is checked (Step S32).

The validity check processing unit 51 receives the result of the determination of the validity of the public key certificate from the validity management unit 52, which is the apparatus through which the validity of the public key certificate is checked (Step S33).

The validity check processing unit 51 transmits the result of the determination of the validity of the public key certificate to the communication apparatus 20, which is the apparatus that has transmitted the revocation check request (Step S34).

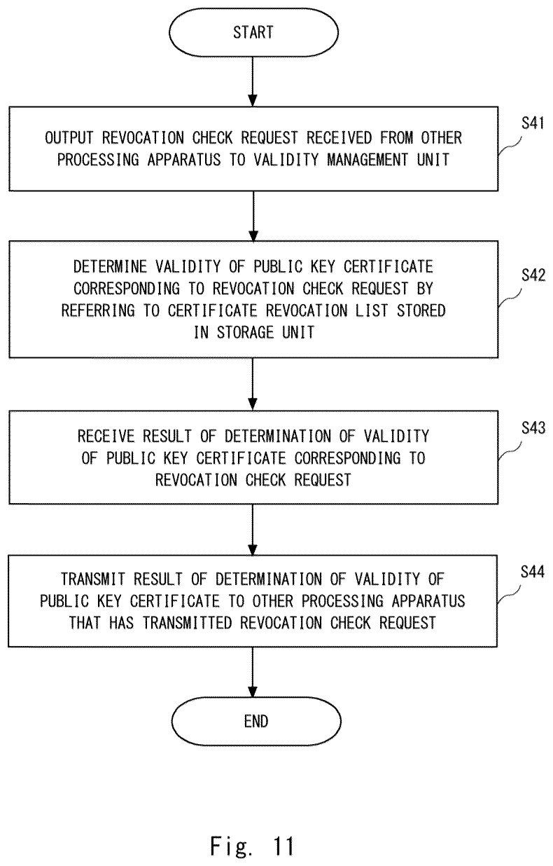

FIG. 11 is a flowchart showing another example of processing operations performed by the processing apparatus according to the present disclosure. The processing flow shown in FIG. 11 starts when the validity check processing unit 51 receives a revocation check request for a public key certificate. FIG. 11 shows a processing flow that is performed when the validity check processing unit 51 of the processing apparatus 50 receives a revocation check request from another processing apparatus 50. Note that as the processing flow, a flow of processes performed by the processing apparatus 50-1 will be described hereinafter.

The validity check processing unit 51 outputs the received revocation check request to the validity management unit 52 of the processing apparatus 50-1 (Step S41).

The validity management unit 52 determines the validity of the public key certificate corresponding to the revocation check request received from the validity check processing unit 51 by referring to the certificate revocation list stored in the storage unit 34 (Step S42).

The validity management unit 52 outputs the result of the determination of the validity of the public key certificate to the validity check processing unit 51 (Step S43).

The validity check processing unit 51 transmits the result of the determination of the validity of the public key certificate received from the validity management unit 52 to the other processing apparatus 50 that has transmitted the revocation check request (Step S44).

As described above, according to the third example embodiment, in the system 3, each of the processing apparatuses 50-1, 50-2, and 50-3 has a function for managing the validity of a public key certificate (i.e., includes the validity management unit 52). That is, the function for managing the validity of a public key certificate is disposed in a distributed manner in the system 3.

By the above-described configuration of the system 3, it is possible to improve the resiliency of the function for managing the validity of a public key certificate.

Further, in the processing apparatus 50, the validity check processing unit 51 refers to the management table and selects, as an apparatus through which it checks the validity of the public key certificate, the validity management unit 52 of the transmitting node of the quantum key distribution link having the highest reliability (e.g., the lowest quantum bit error rate) in the management table.

By the above-described configuration of the processing apparatus 50, it is possible to improve the reliability of information about the validity of a public key certificate.

### Other Example Embodiment

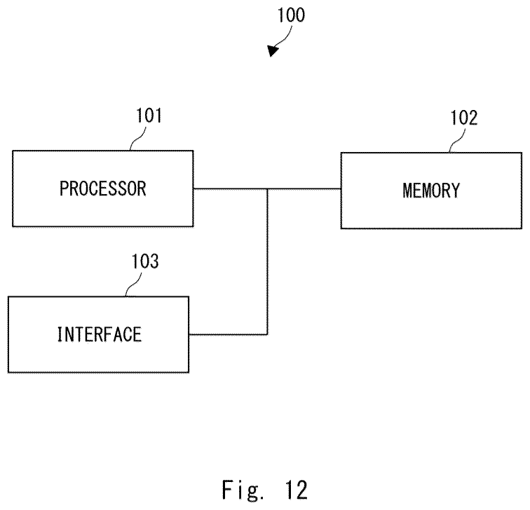

FIG. 12 shows an example of a configuration of a processing apparatus. In FIG. 12, the processing apparatus 100 includes a processing apparatus 101, a memory 102, and an interface 103. The processor 101 may be, for example, a microprocessor, an MPU (Micro Processing Unit), or a CPU (Central Processing Unit). The processor 101 may include a plurality of processors. The memory 102 is composed of a combination of a volatile memory and a nonvolatile memory. The memory 102 may include a storage disposed remotely from the processor 101. In this case, the processing apparatus 101 may access the memory 102 through an I (Input)/O (Output) interface (not shown).

Each of the processing apparatuses 10, 30 and 50 according to the first to the third example embodiments can have the configuration shown in FIG. 12. Each of the validity check processing apparatuses 11, 31 and 51, the validity management units 12, 32 and 52, the inspection units 13, 33, and 53, the quantum bit error rate reporting unit 56, and the QKD function unit 57 of the processors 10, 30 and 50 according to the first to the third example embodiments may be implemented by having the processor 101 load and execute a program stored in the memory 102. That is, the processors 10, 30 and 50 according to the first to the third example embodiments may be implemented by software. The storage units 34 and 54, and the holding unit 55 may be implemented by the memory 102. The program can be stored and supplied to each of the processing apparatuses 10, 30 and 50 by using various types of non-transitory computer readable media. Examples of non-transitory computer readable media include magnetic recording media (e.g., flexible disks, magnetic tapes, and hard disk drives) and magneto-optical recording media (e.g., magneto-optical disks). Examples of non-transitory computer readable media also include CD-ROM (Read Only Memory), CD-R, and CD-R/W. Examples of non-transitory computer readable media also include semiconductor memories. Examples of semiconductor memories include mask ROM, PROM (Programmable ROM), EPROM (Erasable PROM), flash ROM, and RAM (Random Access Memory). Alternatively, the program can be supplied to each of the processing apparatuses 10, 30 and 50 by using various types of transitory computer readable media. Examples of transitory computer readable media include electrical signals, optical signals, and electromagnetic waves. The transitory computer readable media can supply the program to each of the processing apparatuses 10, 30 and 50 through a wired channel such as an electric wire and an optical fiber, or through a wireless channel.

Alternatively, each of the validity check processing apparatuses 11, 31 and 51, the validity management units 12, 32 and 52, the inspection units 13, 33, and 53, the quantum bit error rate reporting unit 56, and the QKD function unit 57 of the processors 10, 30 and 50 according to the first to the third example embodiments may be implemented by dedicated hardware. Further, some or all of the components may be implemented by general-purpose or dedicated circuitry, a processor, or a combination thereof. These components may be formed by a single computer chip or by a plurality of computer chips connected to each other through a bus. Some or all of the components of each apparatus may be implemented by a combination of the above-mentioned circuitry or the like and a program(s). Further, a CPU (Central Processing Unit), a GPU (Graphics Processing Unit), an FPGA (Field-Programmable Gate Array), a quantum processor (quantum computer control chip), or the like may be used as the processor.

Further, when some or all of the components of the processing apparatuses 10, 30 and 50 according to the first to the third example embodiments are implemented by a plurality of information processing apparatuses, circuits, or the like, the plurality of information processing apparatuses, circuits, or the like may be disposed at one place in a concentrated manner or distributed over a plurality of places. For example, the information processing apparatuses, circuits, or the like may be implemented in the form of a client-server system, a cloud computing system, or the like in which components or the like are connected to each other through a communication network. Further, the functions of the processing apparatuses 10, 30 and 50 according to the first to the third example embodiments may be provided in the form of SaaS (Software as a Service).

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### (Supplementary Note 1)

A program for causing a processing apparatus for which a normal environment and a secured environment are provided to perform processes including:
receiving a revocation check request for a public key certificate in the normal environment;
outputting information about validity of a public key certificate corresponding to the received revocation check request in the normal environment; and
inspecting normality of the normal environment in the secured environment.

### (Supplementary Note 2)

The program described in Supplementary note 1, wherein the processes further include: acquiring a certificate revocation list used for a determination of the validity and storing the acquired certificate revocation list in a first storage unit in the normal environment; and detecting tampering with the first storage unit in the secured environment.

### (Supplementary Note 3)

The program described in Supplementary note 2, wherein the processes further include determining validity of a public key certificate corresponding to the revocation check request by referring to the stored certificate revocation list in the normal environment.

### (Supplementary Note 4)

The program described in Supplementary note 3, wherein the information about the validity includes a result of the determination of the validity.

### (Supplementary Note 5)

The program described in any one of Supplementary notes 1 to 4, wherein
the processing apparatus is a trusted node configured to transmit and receive an encryption key by using a quantum key distribution link,
the trusted node is connected to each of at least one other trusted node through a quantum key distribution link, and
the processes further include:
holding a corresponding relationship in which at least one quantum key distribution link, at least one other quantum key distribution link, and reliability of each of the quantum key distribution links are associated with each other, each of the at least one quantum key distribution link being a quantum key distribution link of which the trusted node is a transmitting node and each of the at least one other trusted node is a receiving node, and each of the at least one other quantum key distribution link being a quantum key distribution link of which each of the at least one other trusted node is a transmitting node and the trusted node is a receiving node; and
selecting, among the trusted node and the at least one other trusted node, a transmitting node of a quantum key distribution link having highest reliability in the corresponding relationship as an apparatus through which validity of a public key certificate corresponding to the revocation check request is checked.

### (Supplementary Note 6)

The program described in Supplementary note 5, wherein a parameter related to the reliability is a quantum bit error rate.

### (Supplementary Note 7)

The program described in any one of Supplementary notes 1 to 6, wherein the processes further include transmitting the information about the validity to the apparatus that has transmitted the revocation check request.

### (Supplementary Note 8)

The program described in any one of Supplementary notes 1 to 7, wherein the revocation check request includes a public key certificate of which revocation is to be checked.

### (Supplementary Note 9)

A processing apparatus for which a normal environment and a secured environment are provided, comprising:
a validity check processing unit configured to operate in the normal environment and receive a revocation check request for a public key certificate;
a validity management unit configured to operate in the normal environment and output information about validity of a public key certificate corresponding to the received revocation check request; and
an inspection unit configured to operate in the secured environment and inspect normality of the validity management unit.

### (Supplementary Note 10)

The processing apparatus described in Supplementary note 9, wherein
the validity management unit acquires a certificate revocation list used for a determination of the validity and stores the acquired certificate revocation list in a first storage unit; and
the inspection unit detects tampering with the first storage unit.

### (Supplementary Note 11)

The processing apparatus described in Supplementary note 10, wherein the validity management unit determines validity of a public key certificate corresponding to the revocation check request by referring to the stored certificate revocation list in the normal environment.

### (Supplementary Note 12)

The processing apparatus described in Supplementary note 11, wherein the validity management unit outputs a result of the determination of the validity as information about the validity.

### (Supplementary Note 13)

The processing apparatus described in any one of Supplementary notes 9 to 12, wherein
the processing apparatus is a trusted node configured to transmit and receive an encryption key by using a quantum key distribution link,
the trusted node is connected to each of at least one other trusted node through a quantum key distribution link, and
the processing apparatus further comprises a holding unit configured to hold a corresponding relationship in which at least one quantum key distribution link, at least one other quantum key distribution link, and reliability of each of the quantum key distribution links are associated with each other, each of the at least one quantum key distribution link being a quantum key distribution link of which the trusted node is a transmitting node and each of the at least one other trusted node is a receiving node, and each of the at least one other quantum key distribution link being a quantum key distribution link of which each of the at least one other trusted node is a transmitting node and the trusted node is a receiving node; and
the validity check processing unit selects, among the validity management unit of the trusted node and a validity management unit of the at least one other trusted node, a validity management unit of a transmitting node of a quantum key distribution link having highest reliability in the corresponding relationship as a unit through which validity of a public key certificate corresponding to the revocation check request is checked.

### (Supplementary Note 14)

The processing apparatus described in Supplementary note 13, wherein a parameter related to the reliability is a quantum bit error rate.

### (Supplementary Note 15)

The processing apparatus described in any one of Supplementary notes 9 to 14, wherein the validity check processing unit transmits the information about the validity to the apparatus that has transmitted the revocation check request.

### (Supplementary Note 16)

The processing apparatus described in any one of Supplementary notes 9 to 15, wherein the revocation check request includes a public key certificate of which revocation is to be checked.

### (Supplementary Note 17)

A method performed by a processing apparatus for which a normal environment and a secured environment are provided, comprising:
receiving a revocation check request for a public key certificate in the normal environment;
outputting information about validity of a public key certificate corresponding to the received revocation check request in the normal environment; and
inspecting normality of the normal environment in the secured environment.

### (Supplementary Note 18)

The method described in Supplementary note 17, further comprising:
acquiring a certificate revocation list used for a determination of the validity and storing the acquired certificate revocation list in a first storage unit in the normal environment; and
detecting tampering with the first storage unit in the secured environment.

### (Supplementary Note 19)

The method described in Supplementary note 18, further comprising determining validity of a public key certificate corresponding to the revocation check request by referring to the stored certificate revocation list in the normal environment.

### (Supplementary Note 20)

The method described in Supplementary note 19, wherein the information about the validity includes a result of the determination of the validity.

### (Supplementary Note 21)

The method described in any one of Supplementary notes 17 to 20, wherein
the processing apparatus is a trusted node configured to transmit and receive an encryption key by using a quantum key distribution link,
the trusted node is connected to each of at least one other trusted node through a quantum key distribution link, and
the method further comprises:
holding a corresponding relationship in which at least one quantum key distribution link, at least one other quantum key distribution link, and reliability of each of the quantum key distribution links are associated with each other, each of the at least one quantum key distribution link being a quantum key distribution link of which the trusted node is a transmitting node and each of the at least one other trusted node is a receiving node, and each of the at least one other quantum key distribution link being a quantum key distribution link of which each of the at least one other trusted node is a transmitting node and the trusted node is a receiving node; and
selecting, among the trusted node and the at least one other trusted node, a transmitting node of a quantum key distribution link having highest reliability in the corresponding relationship as an apparatus through which validity of a public key certificate corresponding to the revocation check request is checked.

### (Supplementary Note 22)

The method described in Supplementary note 21 wherein a parameter related to the reliability is a quantum bit error rate.

### (Supplementary Note 23)

The method described in any one of Supplementary notes 17 to 22, further comprising transmitting the information about the validity to the apparatus that has transmitted the revocation check request.

(supplementary Note 24)

The method described in any one of Supplementary notes 17 to 23, wherein the revocation check request includes a public key certificate of which revocation is to be checked.

What is claimed is:

1. A processing apparatus for which a normal environment and a secured environment are provided, comprising:
at least one memory storing instructions, and
at least one processor configured to execute the instructions to;
receive a revocation check request for a public key certificate in the normal environment;
output information about validity of a public key certificate corresponding to the received revocation check request in the normal environment; and
inspect normality of the normal environment in the secured environment.

2. The processing apparatus according to claim 1, wherein the at least one processor configured to execute the instructions to:
acquire a certificate revocation list used for a determination of the validity and storing the acquired certificate revocation list in a first storage in the normal environment; and
detect tampering with the first storage in the secured environment.

3. The processing apparatus according to claim 2, wherein the at least one processor configured to execute the instructions to determine validity of a public key certificate corresponding to the revocation check request by referring to the stored certificate revocation list in the normal environment.

4. The processing apparatus according to claim 3, wherein the information about the validity includes a result of the determination of the validity.

5. The processing apparatus according to claim 1, wherein
the processing apparatus is a trusted node configured to transmit and receive an encryption key by using a quantum key distribution link,
the trusted node is connected to each of at least one other trusted node through a quantum key distribution link, and
the at least one processor configured to execute the instructions to:
hold a corresponding relationship in which at least one quantum key distribution link, at least one other quantum key distribution link, and reliability of each of the quantum key distribution links are associated with each other, each of the at least one quantum key distribution link being a quantum key distribution link of which the trusted node is a transmitting node and each of the at least one other trusted node is a receiving node, and each of the at least one other quantum key distribution link being a quantum key distribution link of which each of the at least one other trusted node is a transmitting node and the trusted node is a receiving node; and
select, among the trusted node and the at least one other trusted node, a transmitting node of a quantum key distribution link having highest reliability in the corresponding relationship as an apparatus through which validity of a public key certificate corresponding to the revocation check request is checked.

6. The processing apparatus according to claim 5, wherein a parameter related to the reliability is a quantum bit error rate.

7. The processing apparatus according to claim 1, wherein the at least one processor configured to execute the instructions to transmit the information about the validity to the apparatus that has transmitted the revocation check request.

8. The processing apparatus according to claim 1, wherein the revocation check request includes a public key certificate of which revocation is to be checked.

9. A method performed by a processing apparatus for which a normal environment and a secured environment are provided, comprising:
receiving a revocation check request for a public key certificate in the normal environment;
outputting information about validity of a public key certificate corresponding to the received revocation check request in the normal environment; and
inspecting normality of the normal environment in the secured environment.

10. A non-transitory computer-readable medium storing a program for causing a processing apparatus for which a normal environment and a secured environment are provided to perform processes including:
receiving a revocation check request for a public key certificate in the normal environment;
outputting information about validity of a public key certificate corresponding to the received revocation check request in the normal environment; and
inspecting normality of the normal environment in the secured environment.
